(19) United States
(12) Patent Application Publication
(10) Pub. No.: US 2025/0222886 A1
(43) Pub. Date: Jul. 10, 2025

(54) CONTROL APPARATUS AND POWER SUPPLY SYSTEM

(71) Applicant: DENSO CORPORATION, Kariya-city (JP)

(72) Inventor: Tetsuo MORITA, Kariya-city (JP)

(73) Assignee: DENSO CORPORATION, Kariya-city (JP)

(21) Appl. No.: 19/090,704

(22) Filed: Mar. 26, 2025

Related U.S. Application Data
(62) Division of application No. 17/986,320, filed on Nov. 14, 2022.
Application No. 17/986,320 is a continuation of application No. PCT/JP2021/017359, filed on May 6, 2021.

(30) Foreign Application Priority Data
May 13, 2020 (JP) 2020-084632

(51) Int. Cl. B60R 16/03; B60R 16/033; H02J 1/10; H02J 7/00

(52) U.S. Cl. CPC B60R 16/03; B60R 16/033; H02J 1/102; H02J 1/106; H02J 7/0063; H02J 7/007182; H02J 2310/40

(57) ABSTRACT

In a power supply system, a first system includes a first power supply connected to a first load. A second system includes a second power supply connected to a second load. A connection path connects the systems. An intersystem switch is provided on the connection path. A control apparatus sets the intersystem switch to a closed state and sets a voltage of the first power supply to be higher than a voltage of the second power supply to be a first state in which power supply is performed from the first power supply to the loads. In response to a reverse-direction current from the second system to the first system flowing to 10 the connection path in the first state, the control apparatus sets the intersystem switch to an open state to be a second state in which power supply is performed from the second power supply to the second load.

### CROSS-REFERENCE TO RELATED APPLICATION

The present application is a divisional application of U.S. patent application Ser. No. 17/986,320, filed Nov. 14, 2022, which is a continuation application of International Application No. PCT/JP2021/017359, filed on May 6, 2021, which claims priority to Japanese Patent Application No. 2020-084632, filed on May 13, 2020. The contents of these applications are incorporated herein by reference in their entirety.

### BACKGROUND

### Technical Field

The present disclosure relates to a control apparatus of a power supply system and a power supply system.

### Related Art

A power supply system that is applicable to a vehicle and supplies electric power to various apparatuses of the vehicle has been known. For example, to prevent loss of all function of a load that provides a function required for driving of the vehicle, a power supply system that has a first load and a second load as loads that provide a single function is known.

### SUMMARY

One aspect of the present disclosure provides a control apparatus that is applicable to a power supply system. The power supply system includes: a first system including a first power supply connected to a first load; a second system including a second power supply connected to a second load; a connection path connecting the first and second systems to each other; and an intersystem switch provided on the connection path. The control apparatus sets the intersystem switch to a closed state and sets a voltage of the first power supply to be higher than a voltage of the second power supply to be a first state in which power supply is performed from the first power supply to the first and second loads. In response to a reverse-direction current oriented from the second system to the first system flowing to the connection path in the first state, the control apparatus sets the intersystem switch to an open state to be a second state in which, power supply is performed from the second power supply to the second load.

### BRIEF DESCRIPTION OF THE DRAWINGS

In the accompanying drawings:

FIG. 1 is an overall configuration diagram illustrating a power supply system according to a first embodiment;

FIG. 2 is a flowchart illustrating steps in a control process according to the first embodiment;

FIG. 3 is a timing chart illustrating an example of the control process according to the first embodiment;

FIG. 4 is a flowchart illustrating steps in a control process according to a second embodiment;

FIG. 5 is a timing chart illustrating an example of the control process according to the second embodiment; and

FIG. 6 is an overall configuration diagram illustrating a power supply system according to another embodiment.

### DESCRIPTION OF THE EMBODIMENTS

In recent years, a power supply system that is applicable to a vehicle and supplies electric power to various apparatuses of the vehicle has been known. In the power supply system, for example, during driving of the vehicle, if an abnormality occurs in a load that provides a function required for driving of the vehicle, such as an electric brake apparatus or an electric steering apparatus, and all function of the load is lost as a result, driving of the vehicle cannot be continued. To prevent loss of all function of the load even during an occurrence of an abnormality during driving of the vehicle, a power supply system that has a first load and a second load as loads that provide a single function is known.

For example, as this power supply system, in Japanese Patent Publication No. 6432355, a power supply system that includes a first system that includes a first battery that is connected to a first load and a second system that includes a second battery that is connected to a second load is known. In this power supply system, an intersystem switch is provided on a connection path that connects the first and second systems. The intersystem switch is set to an open state by a control apparatus when a short circuit occurs in one system and a short-circuit current flows through the connection path. As a result, the function required for driving of the vehicle is ensured by the load in the other system in which a short circuit has not occurred, and driving of the vehicle can be continued.

In the above-described power supply system, even in a state in which the short-circuit current flows to the connection path, it is thought difficult to differentiate between whether current generation thereof is actually due to a short circuit or is a load current that flows between differing systems. When a short circuit is determined to have occurred regardless of the current generation being the load current, as a result of the intersystem switch being set to the open state, mutual power supply between the first and second systems cannot be performed. In addition, when a short circuit is determined to have not occurred even when the current generation is actually due to a short circuit, driving of the load may not being able to be continued.

It is thus desired to to provide a control apparatus for a power supply system that is capable of continuing driving of a load even when a short circuit occurs, while suppressing erroneous detection of a short circuit.

A first exemplary embodiment of the present disclosure provides a control apparatus that is applicable to a power supply system. The power supply system includes: a first system that includes a first power supply that is connected to a first load; a second system that includes a second power supply that is connected to a second load; a connection path that connects the first and second systems to each other; and an intersystem switch that is provided on the connection path. The control apparatus includes a first control unit and a second control unit. The first control unit sets the intersystem switch to a closed state and sets a first voltage that is a voltage of the first power supply to be higher than a second voltage that is a voltage of the second power supply to be a first state in which power supply is performed from the first power supply to the first and second loads. In response to a reverse-direction current that is oriented from the second system to the first system flowing to the connection path in the first state, the second control unit sets the intersystem switch to an open state to be a second state in which power supply is performed from the second power supply to the second load.

The first and second systems have a power supply and are connected to each other by the connection path. In this configuration, mutual power supply can be performed between the first and second systems, and redundant power supply to the first load and the second load by the first power supply and the second power supply can be performed. Here, if a short circuit occurs in either of the first and second systems, a short-circuit current flows through the connection path. Therefore, detection of the short circuit can be performed by the current generation. However, even in a state in which a short-circuit current flows to the connection path, it is considered difficult to differentiate between whether the current generation is actually due to a short circuit or is a load current that flows between differing systems.

In this configuration, power supply from the first power supply to the first load and the second load is performed by the first voltage that is the voltage of the first power supply being set to be higher than the second voltage that is the voltage of the second power supply. Therefore, during driving of the first load and the second load, a load current flowing through the connection path from the second system to the first system is suppressed. As a result, when a reverse-direction current that is oriented from the second system to the first system flows to the connection path, the current generation can be determined to be actually due to a short circuit. As a result of the intersystem switch being set to the open state, power supply can be performed from the second power supply to the second load. That is, even when a short circuit occurs in the first system, driving of the second load can be continued. Consequently, driving of a load can be continued even when a short circuit occurs, while erroneous detection of a short circuit is suppressed.

According to a second exemplary embodiment, the first control unit sets a voltage that has a predetermined voltage difference relative to the second voltage as a target voltage and variably controls the first voltage based on the target voltage.

In this configuration, the first power supply can variably control the first voltage, and controls the first voltage based on the target voltage that has the predetermined voltage difference relative to the second voltage. Therefore, the predetermined voltage difference is ensured between the first voltage and the second voltage when the first voltage is the target voltage. As a result, during driving of the first load and the second load, even when the load current that flows through the connection path from the second system to the first system varies, the reverse-direction current can be suppressed, by the predetermined voltage difference, from flowing by way of the connection path. Consequently, erroneous detection of a short circuit can be suppressed.

According to a third exemplary embodiment, the first power supply includes a voltage generating unit that generates the first voltage as a drive voltage of the first load and the second load. The power supply includes a power storage apparatus that sets an inter-terminal voltage as the second voltage. The first control unit variably controls the first voltage that is generated by the voltage generating unit based on the target voltage.

In this configuration, the first power supply includes the voltage generating unit. Thus, the first voltage that serves as the drive voltage of the first load and the second load can be generated, and the first voltage can be supplied to each load. In addition, the second power supply includes the power storage apparatus. Thus, even if a power-supply failure occurs in the first system, power supply to the loads can be continued.

According to a fourth exemplary embodiment, the power storage apparatus is capable of being charged by power supply from the voltage generating unit. The first control unit sets the target voltage when the power storage apparatus is being charged to be higher than that when the power storage apparatus is not being charged.

The power storage apparatus is supplied charging power as appropriate from the voltage generating unit based on decrease in the second voltage. During driving of the first load and the second load, when the power storage apparatus is supplied charging power from the voltage generating unit through the connection path, variations in a charging current that flows through the connection path occur as a result of residual capacity of the power storage apparatus. As a result, when a reverse-direction current flows by way of the connection path, a short circuit is erroneously detected. In this configuration, the target voltage when the power storage apparatus is being charged is set to be higher than that when the power storage apparatus is not being charged. Consequently, a reverse-direction current is suppressed from flowing, and erroneous detection of a short circuit can be favorably suppressed.

According to a fifth exemplary embodiment, the first control unit acquires drive amount information that indicates a drive amount of the first load and the second load. When the drive amount indicated by the drive amount information is greater than a predetermined threshold, the first control unit sets the first voltage to be higher than that when the drive amount is less than the threshold.

An amount of change in the current that flows through the connection path is proportional to the drive amount of the first load and the second load. Therefore, when the drive amount is large, the amount of change in the current that flows through the connection path increases. As a result, when a reverse-direction current flows by way of the connection path, a short circuit is erroneously detected. In this configuration, the first voltage when the drive amount is greater than the threshold is set to be higher than that when the drive amount is less than the threshold. Consequently, a reverse-direction current is suppressed from flowing, and erroneous detection of a short circuit is favorably suppressed.

According to a sixth exemplary embodiment, the first control unit acquires drive amount information that indicates a drive amount of the first load and the second load. The second control unit stops switching of the intersystem switch to the open state even when the reverse-direction current is determined to be flowing, in response to the drive amount indicated by the drive amount information acquired by the first control unit switching from a state of being greater than a predetermined threshold to a state of being less.

The amount of change in the current that flows through the connection path is proportional to the drive amount of the first load and the second load. In particular, when the drive amount decreases, the second voltage becomes unstable and the current that flows through the connection path tends to increase. In this case, when a reverse-direction current is determined to flow to the connection path, the intersystem switch is erroneously set to the open state as a result of erroneous detection of a short circuit. In this configuration, switching of the intersystem switch to the open state is stopped when the drive amount switches from the state of being greater than the threshold to the state of being less. Consequently, the intersystem switch can be suppressed from being erroneously set to the open state as a result of erroneous detection of a short circuit.

According to a seventh exemplary embodiment, the power supply system is mounted to a vehicle. The first load and the second load provide at least one function required for driving of the vehicle that includes a driving assistance function of the vehicle. The vehicle is capable of traveling in a first mode in which the driving assistance function is used and traveling in a second mode in which the driving assistance function is not used. The first control unit sets the first state in the first mode. The second control unit sets the second state in response to the reverse-direction current being determined to be flowing in the first mode.

In the power supply system that is applied to a vehicle that has the first load and the second load as loads that provide a function required for driving and a driving assistance function, there is a power supply system that is capable of switching between traveling in a first mode in which the driving assistance function is used and traveling in a second mode in which the driving assistance function is not used. In this configuration, the first state is set in the first mode. The second state is set in response to a reverse-direction current being determined to flow to the connection path in the first mode. Consequently, in the first mode in which the driving assistance function is used, driving of the load can be continued and the driving assistance function can be continuously used even when a short circuit occurs, while erroneous detection of a short circuit is suppressed.

According to an eighth exemplary embodiment, the first control unit controls the first voltage to be a target voltage that is higher than the second voltage. The control apparatus includes: a voltage determining unit that determines that the first voltage has fallen below the target voltage in the first state, and a mode control unit that switches a traveling mode of the vehicle from the first mode to the second mode in response to the first voltage being determined to have fallen below the target voltage.

In the first state, for example, the first voltage may not be able to be increased to the target voltage as a result of an abnormality in the first power supply or decrease in power generation capability of the first power supply. In this case, voltage difference between the first voltage and the second voltage decreases, and a short circuit is erroneously detected depending on a magnitude of variations in the drive amount. When the intersystem switch is erroneously set to the open state as a result of erroneous detection of a short circuit in the first mode in which the driving assistance function is used, redundant power supply to each load cannot be performed in the driving assistance function. In this regard, in response to the first voltage being determined to have fallen below the target voltage, the traveling mode of the vehicle is switched from the first mode to the second mode. Consequently, the driving assistance function being continuously used in the state in which redundant power supply to each load cannot be performed can be suppressed.

According to a ninth exemplary embodiment, the power supply system that includes the above-described control apparatus includes the above-described control apparatus, the above-described first power supply, the above-described second power supply, the above-describe connection path, and the above-described intersystem switch. As a result of this configuration, driving of a load can be continued even when a short circuit occurs, while erroneous detection of a short circuit is suppressed.

The above-described exemplary embodiments of the present disclosure will be further clarified through the following detailed description, with reference to the accompanying drawings.

### First Embodiment

An embodiment in which a power supply system of the present disclosure is realized as an onboard power supply system 100 will hereinafter be described with reference to the drawings.

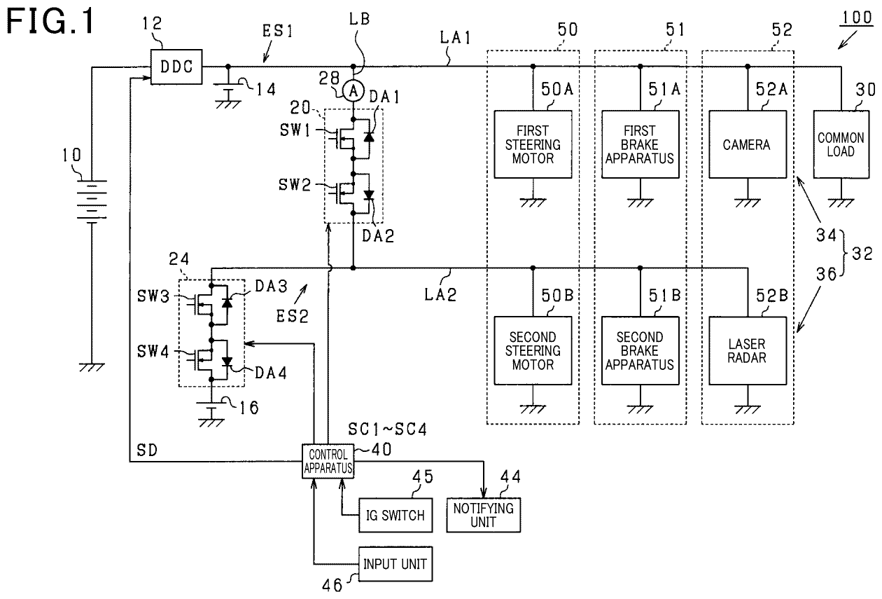

As shown in FIG. 1, the power supply system 100 is a system that supplies electric power to a common load 30 and a specific load 32. The power supply system 100 includes a high-voltage storage battery 10, a direct current-to-direct current (DCDC) converter (hereafter, simply a converter) 12, a first low-voltage storage battery 14, a second low-voltage storage battery 16 that serves as a power storage apparatus, a first switch unit 20, a second switch unit 24, and a control apparatus 40.

The high-voltage storage battery 10 has a higher rated voltage (such as several hundred V) than the first low-voltage storage battery 14 and the second low-voltage storage battery 16. For example, the high-voltage storage battery 10 may be a lithium-ion storage battery. The converter 12 converts electric power that is supplied from the high-voltage storage battery 10 to electric power of a first voltage VA that serves as a drive voltage (such as 12 V) of the common load 30 and the specific load 32, and supplies the converted electric power to the common load 30 and the specific load 32.

The common load 30 is an electrical load (hereafter, simply a load) that is not used for driving assistance of the vehicle. For example, the common load 30 may be air-conditioning, audio equipment, or power windows.

Meanwhile, the specific load 32 is a load that provides at least one function that is used for driving assistance of the vehicle. Specifically, the specific load 32 is a load that provides a driving assistance function of the vehicle. For example, the specific load 32 may be an electric power steering apparatus 50 that controls steering of the vehicle, an electric brake apparatus 51 that applies braking force to a wheel, or a traveling control apparatus 52 that monitors a state of a vehicle periphery.

When an abnormality occurs in these specific loads 32 and functions thereof are lost, driving assistance cannot be performed. Therefore, the specific load 32 includes a first load 34 and a second load 36 that are redundantly provided for each function to prevent the function of the specific load 32 from being lost even when an abnormality occurs. Specifically, the electric power steering apparatus 50 includes a first steering motor 50A and a second steering motor 50B. The electric brake apparatus 51 includes a first brake apparatus 51A and a second brake apparatus 51B. The traveling control apparatus 52 includes a camera 52A and a laser radar 52B. The first steering motor 50A, the first brake apparatus 51A, and the camera 52A correspond to the first load 34. The second steering motor 50B, the second brake apparatus 51B, and the laser radar 52B correspond to the second load 36.

The first load 34 and the second load 36 actualize a single function in combination. However, the first load 34 and the second load 36 are each capable of actualizing a portion of the function even by itself. For example, in the electric power steering apparatus 50, free steering of the vehicle can be performed by the first steering motor 50A and the second steering motor 50B. The steering of the vehicle can be performed by the steering motor 50A or 50B while certain restrictions are placed on steering speed, steering range, and the like.

The specific load 32 actualizes a function for assisting in control by a driver in manual driving. In addition, in autonomous driving in which behavior, such as traveling or stopping of the vehicle, is automatically controlled, the specific load 32 actualizes a function required for autonomous driving. Therefore, the specific load 32 can be considered to be a load that provides at least one function required for driving of the vehicle.

The first load 34 is connected to the converter 12 by a first system internal path LA1. The first low-voltage storage battery 14 and the common load 30 are connected to the first system internal path LA1. For example, the first low-voltage storage battery 14 may be a lead storage battery. According to the present embodiment, a first system ES1 is configured by the converter 12, the first low-voltage storage battery 14, the common load 30, and the first load 34 that are connected by the first system internal path LA1. Here, according to the present embodiment, the converter 12 and the first low-voltage storage battery 14 correspond to a “first power supply.” The converter 12 corresponds to a “voltage generating unit.”

In addition, the second load 36 is connected to the second low-voltage storage battery 16 by a second system internal path LA2. For example, the second low-voltage storage battery 16 may be a lithium-ion storage battery. According to the present embodiment, a second system ES2 is configured by the second low-voltage storage battery 16 and the second load 36 that are connected by the second system internal path LA2. Here, according to the present embodiment, the second low-voltage storage battery 16 corresponds to a “second power supply.”

The first switch unit 20 is provided on a connection path LB that connects the first and second systems to each other. The connection path LB connects the first system internal path LA1 and the second system internal path LA2. The first switch unit 20 includes a first switch SW1 and a second switch SW2 that are connected in series. In the first switch unit 20, the first switch SW1 is provided further towards the first system ES1 side than the second switch SW2. Here, according to the present embodiment, the first switch SW1 and the second switch SW2 correspond to an “intersystem switch.”

According to the present embodiment, an N-channel metal-oxide-semiconductor field-effect transistor (MOSFET) (hereafter, simply a MOSFET) is used as the first and second switches SW1 and SW2. Therefore, a first parasitic diode DA1 is connected in parallel to the first switch SW1. A second parasitic diode DA2 is connected in parallel to the second switch SW2. According to the present embodiment, the first and second switches SW1 and SW2 are connected in series such that orientations of the first and second parasitic diodes DA1 and DA2 are opposite each other. Specifically, the first parasitic diode DA1 is arranged such that an anode is on the second system ES2 side and a cathode is on the first system ES1 side. The second parasitic diode DA2 is arranged such that the anode is on the first system ES1 side and the cathode is on the second system ES2 side.

A current detecting unit 28 is provided on the connection path LB. The current detecting unit 28 is provided in a portion of the connection path LB that is further towards the first system ES1 side than the first switch unit 20. The current detecting unit 28 detects a magnitude and a direction of an intersystem current IA that flows to this portion. Specifically, the current detecting unit 28 sets the direction of the intersystem current IA that flows to the connection path LB from the first system ES1 to the second system ES2 as positive, and detects the magnitude of the intersystem current IA. A detection value of the current detecting unit 28 is inputted to the control apparatus 40.

The second switch unit 24 is provided on the second system internal path LA2. Specifically, the second switch unit 24 includes a third switch SW3 and a fourth switch SW4 that are connected in series and are provided on the second system internal path LA2 between a connection point with the connection path LB and the second low-voltage storage battery 16. In the second switch unit 24, the third switch SW3 is provided further towards the connection path LB side than the fourth switch SW4.

According to the present embodiment, the MOSFET is used as the third and fourth switches SW3 and SW4. Therefore, a third parasitic diode DA3 is connected in parallel to the third switch SW3. A fourth parasitic diode DA4 is connected in parallel to the fourth switch SW4. According to the present embodiment, the third and fourth switches SW3 and SW4 are connected in series such that orientations of the third and fourth parasitic diodes DA3 and DA4 are opposite each other. Specifically, the third parasitic diode DA3 is arranged such that the anode is on the second low-voltage storage battery 16 side and the cathode is on the connection path LB side. The fourth parasitic diode DA4 is arranged such that the anode is on the connection path LB side and the cathode is on the second low-voltage storage battery 16 side.

The control apparatus 40 acquires the detection value of the current detecting unit 28 and system internal currents that flow to the first and second system internal paths LA1 and LA2. Then, based on the detection value and the system internal currents, the control apparatus 40 generates first to fourth switching signals SC1 to SC4 to operate switching of the first to fourth switches SW1 to SW4, and outputs commands based on the first to fourth switching signals SC1 to SC4 to the first to fourth switches SW1 to SW4. In addition, to control operation of the converter 12, the control apparatus 40 generates a control signal SD and outputs a command based on the control signal SD to the converter 12. As a result of the control signal SD, the first voltage VA that is generated by the converter 12 is variably controlled. In addition, switching between an operating state and an operation-stopped state of the converter 12 is performed.

Furthermore, the control apparatus 40 is connected to a notifying unit 44, an ignition (IG) switch 45, and an input unit 46, and controls these components. The notifying unit 44 is an apparatus that visually or audibly notifies a driver. For example, the notifying unit 44 may be a display or a speaker that is set inside a vehicle cabin. The IG switch 45 is a startup switch of the vehicle. The control apparatus 40 monitors an open/closed state of the IG switch 45. The input unit 46 is an apparatus that receives an operation from the driver. For example, the input unit 46 may be a handle, a lever, a button, a pedal, or a voice input apparatus.

The control apparatus 40 manually drives or autonomously drives the vehicle using the above-described specific load 32. The control apparatus 40 includes a known microcomputer that is configured by a central processing unit (CPU), a memory such as a read-only memory (ROM) or a random access memory (RAM), a flash memory and the like. The CPU actualizes various functions for manual driving and autonomous driving by referencing calculation programs and control data in the memory.

Here, manual driving refers to a state in which driving of the vehicle is controlled by operations by the driver. In addition, autonomous driving refers to a state in which driving of the vehicle is controlled by control content by the control apparatus 40, rather than operations by the driver. Specifically, autonomous driving refers to automated driving at Level 3 or higher among Level 0 to Level 5 of the Levels of Automation prescribed by the National Highway Traffic Safety Administration (NHTSA) of the United States. Level 3 is a level at which the control apparatus 40 controls both steering wheel operation and acceleration/deceleration while observing a traveling environment.

In addition, the control apparatus 40 is capable of providing driving assistance functions such as Lane Keeping Assist (LKA), Lane Change Assist (LCA), and Pre-Crash Safety (PCS) using the above-described specific load 32. The control apparatus 40 is capable of switching a driving mode of the vehicle between a first mode in which the driving assistance functions are used and a second mode in which the driving assistance functions are not used. The vehicle is capable of traveling in each driving mode. The control apparatus 40 switches between the first mode and the second mode based on a switching instruction from the driver through the input unit 46. Here, the first mode includes a mode in which the vehicle is autonomously driven, in addition to a mode in which the vehicle is manually driven by the driver using the driving assistance functions. The second mode is a mode in which the vehicle is manually driven without the driver using the driving assistance functions.

In the first mode, the control apparatus 40 determines whether an abnormality has occurred in the first system ES1 and the second system ES2. When determined that an abnormality has not occurred in either of the first and second systems ES1 and ES2, the control apparatus 40 performs autonomous driving and driving assistance of the vehicle using the first load 34 and the second load 36. As a result, the first and second loads 34 and 36 cooperate to provide a single function required for autonomous driving and driving assistance. According to the present embodiment, an abnormality is a power-supply failure abnormality such as a ground fault or disconnection.

Meanwhile, when an abnormality is determined to have occurred in either of the first and second systems ES1 and ES2, the first and second switches SW1 and SW2 are set to the open state, and the first system ES1 and the second system ES2 are electrically isolated. As a result, even in a case in which an abnormality has occurred in either of the first and second systems ES1 and ES2, the loads 34 and 36 of the other of the s first and second ystems ES1 and ES2 in which an abnormality has not occurred can be driven.

Here, a method for determining a short-circuit current to flow through the connection path LB is known as a method for determining whether an abnormality has occurred in the first system ES1 and the second system ES2. However, in the above-described method, even in a state in which a short-circuit current is flowing to the connection path LB, it is considered difficult to differentiate between whether current generation is actually due to an abnormality or is a load current that flows between the differing systems ES1 and ES2. When an abnormality is determined to have occurred regardless of the current generation being the load current, as a result of the first and second switches SW1 and SW2 being set to the open state, mutual power supply between the first and second systems ES1 and ES2 cannot be performed. In addition, when an abnormality is determined to have not occurred regardless of the current generation being actually due to an abnormality, driving of the loads 34 and 36 cannot be continued.

According to the present embodiment, as a result of the first voltage VA that is generated by the converter 12 being set to a target voltage Vtg that is higher than a second voltage VB that is an interterminal voltage of the second low-voltage storage battery 16, a control process to make the converter 12 supply electric power to the first load 34 and the second load 36 is performed. As a result, during driving of the first load 34 and the second load 36, the load current flowing from the second system ES2 to the first system ES1 through the connection path LB is suppressed. Therefore, when a reverse-direction current that is oriented from the second system ES2 to the first system ES1 is determined to flow to the connection path LB, the current generation can be determined to be actually due to an abnormality. Then, as a result of the first and second switches SW1 and SW2 being set to the open state, power supply from the second low-voltage storage battery 16 to the second load 36 can be performed. That is, driving of the second load 36 can be continued even when a short circuit occurs in the first system ES1. As a result, driving of the loads 34 and 36 can be continued even when a short circuit occurs, while erroneous detection of a short circuit is suppressed.

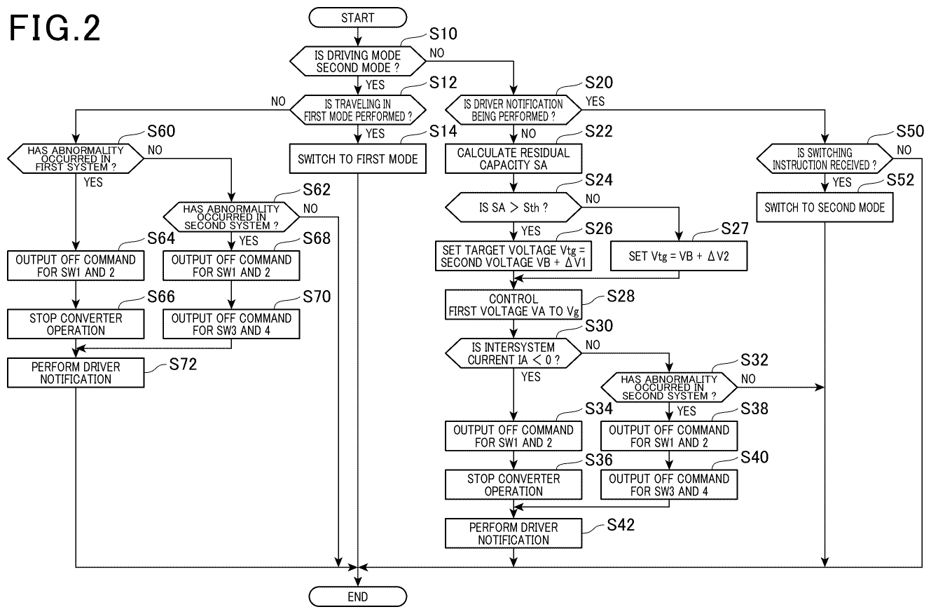

FIG. 2 shows a flowchart of a control process according to the present embodiment. When the IG switch 45 is switched to the closed state, the control apparatus 40 repeatedly performs the control process at every predetermined control cycle. Here, at an initial switching of the IG switch 45 to the closed state, the driving mode of the vehicle is set to the second mode, and the first to fourth switches SW1 to SW4 are set to the closed state.

When the control process is started, first, at step S10, whether the driving mode of the vehicle is the second mode is determined. When an affirmative determination is made at step S10, at step S12, whether traveling of the vehicle in the first mode is performed is determined. For example, when an abnormality has occurred in either of the first system ES1 and the second system ES2, a precondition for execution of the first mode may not be met. Therefore, a negative determination is made at step S12 and the process proceeds to steps S60 and S62.

Meanwhile, when the driver issues an instruction to switch to the first mode and the above-described abnormality has not occurred, the precondition for execution of the first mode is met. Thus, an affirmative determination is made at step S12. In this case, at step S14, the driving mode of the vehicle is switched from the second mode to the first mode, and the control process is ended. For example, the switching to the first mode may be performed when a switching instruction such as an instruction to use the driving assistance function or an instruction for autonomous driving is inputted from the driver through the input unit 46.

Meanwhile, when a negative determination is made at step S10, at step S20, whether driver notification is being performed is determined. Here, driver notification notifies the driver that an abnormality has occurred in either of the first system ES1 and the second system ES2, notifies the driver that the first mode is discontinued, and prompts switching to the second mode.

When a negative determination is made at step S20, at step S22, a residual capacity SA of the second low-voltage storage battery 16 is calculated. For example, the residual capacity SA may be a state of charge (SOC) that indicates a charging state of the second low-voltage storage battery 16. When the second low-voltage battery 16 is in an energizing state (a charging state or a discharging state), the residual capacity SA is calculated using a current integrated value that is a time-integrated value of a charge/discharge current of the second low-voltage storage battery 16.

At step S24, whether the residual capacity SA calculated at step S22 is greater than a predetermined capacity threshold Sth is determined. The second low-voltage storage battery 16 is a storage battery that can be charged by power supply from the converter 12. The capacity threshold Sth is a charging upper-limit capacity of the second low-voltage storage battery 16. Therefore, when the residual capacity SA is less than the capacity threshold Sth, the second low-voltage storage battery 16 is charged by power supply from the converter 12.

When the residual capacity SA is greater than the capacity threshold Sth and the second low-voltage storage battery 16 is not being charged, an affirmative determination is made at step S24. In this case, at step S26, a target voltage Vtg is set such that a voltage difference between the target voltage Vtg and the second voltage VB is a first voltage difference ΔV1, and the process proceeds to step S28. Meanwhile, when the residual capacity SA is less than the capacity threshold Sth and the second low-voltage storage battery 16 is being charged, a negative determination is made at step S24. In this case, at step S27, the target voltage Vtg is set such that the voltage difference between the target voltage Vtg and the second voltage VB is a second voltage difference ΔV2, and the process proceeds to step S28. Here, the second voltage difference ΔV2 is set to a voltage difference that is greater than the first voltage difference ΔV1. That is, in the control process according to the present embodiment, the target voltage Vtg when the second low-voltage storage battery 16 is being charged is set to be higher than that when the second low-voltage storage battery 16 is not being charged. The first and second voltage differences ΔV1 and ΔV2 are set based on characteristics of the second low-voltage storage battery 16 such as the residual capacity SA and a temperature of the second low-voltage storage battery 16, and wiring resistance of the first and second system internal paths LA1 and LA2, and the connection path LB.

At step S28, the first voltage VA is controlled to the target voltage Vtg. As a result, the first voltage VA is higher than the second voltage VB, and a first state is set in which power supply is performed from the converter 12 to the first load 34 and the second load 36. Here, according to the present embodiment, the process at step S28 corresponds to a “first control unit.”

At subsequent steps S30 and S32, an abnormality is determined to have occurred in either of the first system ES1 and the second system ES2. At step S30, it is determined whether an abnormality has occurred in the first system ES1. Specifically, in the first state, whether the reverse-direction current that is oriented from the second system ES2 to the first system ES1 flows to the connection path LB is determined. Specifically, it is determined whether the intersystem current IA that is acquired from the current detecting unit 28 is negative.

When the intersystem current IA that is acquired from the current detecting unit 28 is positive and the reverse-direction current is determined to not be flowing to the connection path LB, a negative determination is made at step S30. In this case, at step S32, it is determined whether an abnormality has occurred in the second system ES2. Specifically, it is determined whether a short-circuit current flows to the second system internal path LA2.

When an abnormality is determined to have not occurred in either of the first and second systems ES1 and ES2, a negative determination is made at step S32. In this case, the control process is ended, and traveling of the vehicle in the first mode is continued.

Meanwhile, when an abnormality is determined to have occurred in either of the first and second systems ES1 and ES2, an open command is outputted to the first and second switches SW1 and SW2, and a process to stop power supply to the side of the system in which the abnormality has occurred is performed.

Specifically, when the intersystem current IA that is acquired by the current detecting unit 28 is negative and the reverse-direction current is determined to flow to the connection path LB, an affirmative determination is made at step S30. In this case, at step S34, the open command is outputted to the first and second switches SW1 and SW2. At subsequent step S36, a command to switch the converter 12 to an operation-stopped state is outputted. As a result, a second state is set in which power supply from the high-voltage storage battery 10 to the first load 34 and the second load 36, and power supply from the second low-voltage storage battery 16 to the first load 34 are stopped, and power supply is performed from the second low-voltage storage battery 16 to the second load 36. Here, according to the present embodiment, the process at step S34 corresponds to a “second control unit.

In addition, when a negative determination is made at step S32, at step S38, the open command is outputted to the first and second switches SW1 and SW2. At subsequent step S40, the open command is outputted to the third and fourth switches SW3 and SW4. As a result, the state is such that power supply from the second low-voltage storage battery 16 to the first load 34 and the second load 36, and power supply from the converter 12 to the second load 36 are stopped, and power supply is performed from the converter 12 to the second load 36.

That is, when an abnormality is determined to have occurred in either of the first and second systems ES1 and ES2, first, the first and second switches SW1 and SW2 are set to the open state, and power supply to the loads 34 and 36 on the side of the system in which an abnormality has not occurred is ensured. Subsequently, power supply from the high-voltage storage battery 10 and the second low-voltage storage battery 16 is stopped, and over-discharge of the storage batteries 10 and 16 is suppressed.

Subsequently, at step S42, the driver is notified of the first mode being discontinued through the notifying unit 44, and the control process is ended.

When an affirmative determination is made at step S20, at step S50, whether an instruction to switch to the second mode is inputted from the driver through the input unit 46 is determined. That is, whether a response from the driver to the notification is received is determined. When a negative determination is made at step S50, the control process is ended. Traveling of the vehicle in the first mode is continued using the loads 34 and 36 on the side of the system in which an abnormality has not occurred.

Meanwhile, when an affirmative determination is made at step S50, at step S52, the driving mode of the vehicle is switched from the first mode to the second mode, and the control process is ended.

At steps S60 and S62, an abnormality is determined to have occurred in either of the first system ES1 and the second system ES2. At step S60, whether an abnormality has occurred in the first system ES1 is determined. When a negative determination is made at step S60, at step S62, whether an abnormality has occurred in the second system ES2 is determined. Here, in the second mode, the first and second switches SW1 and SW2 may be in the open state. Therefore, the occurrence of an abnormality is determined based on whether a short-circuit current flows to the system internal paths LA1 and LA2. When an abnormality is determined to not have occurred in either of the first and second systems ES1 and ES2, a negative determination is made at step S62. In this case, the control process is ended, and traveling of the vehicle in the second mode is continued. Meanwhile, when an abnormality is determined to have occurred in either of the first and second systems ES1 and ES2, the open command is outputted to the first and second switches SW1 and SW2, and power supply to the side of the system in which the abnormality has occurred is stopped.

Specifically, when an affirmative determination is made at step S60, at step S64, the open command is outputted to the first and second switches SW1 and SW2. At subsequent step S66, the command to switch the converter 12 to the operation-stopped state is outputted.

In addition, when an affirmative determination is made at step S62, at step S68, the open command is outputted to the first and second switches SW1 and SW2. At subsequent step S70, the open command is outputted to the third and fourth switches SW3 and SW4.

Subsequently, at step S72, the driver is notified that an abnormality has occurred in either of the first system ES1 and the second system ES2 through the notifying unit 44, and the control process is ended.

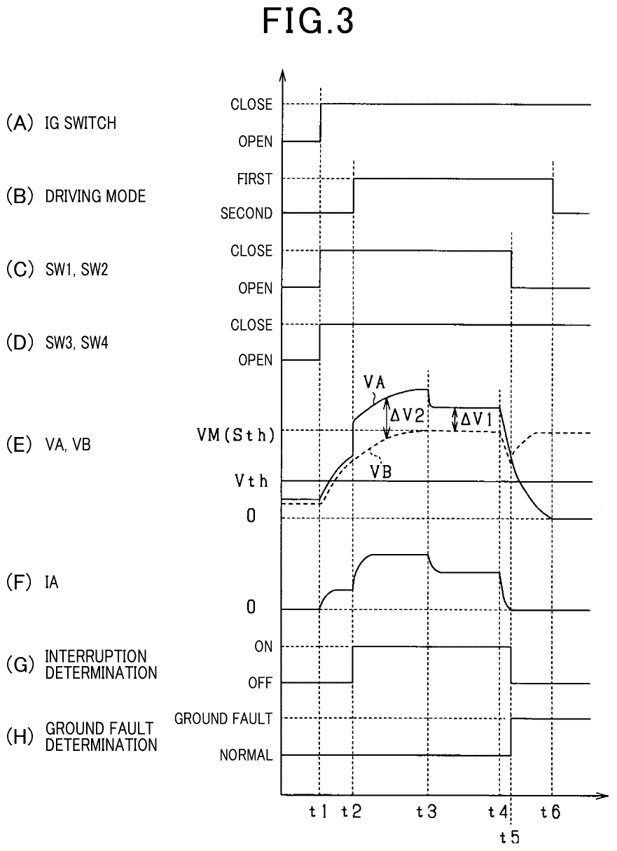

Next, FIG. 3 shows an example of the control process. FIG. 3 shows transitions in the first voltage VA and the second voltage VB when a ground fault occurs in the first system ES1 during traveling of the vehicle in the first mode.

In FIG. 3, (A) shows transitions in the state of the IG switch 45. (B) shows transitions in the driving mode of the vehicle. In addition, (C) shows transitions in the open/closed state of the first and second switches SW1 and SW2. (D) shows transitions in the open/closed state of the third and fourth switches SW3 and SW4. Furthermore, (E) shows transitions in the first voltage VA and the second voltage VB. (F) shows transitions in the intersystem current IA. (G) shows transition values of interruption determination. (H) shows transitions in a determination result regarding ground fault.

Here, the interruption determination refers to determination that a current flows through the connection path LB from the second system ES2 towards the first system ES1. The interruption determination is set to on when the determination is performed and set to off when the determination is not performed. In addition, in FIG. 3(E), the transitions in the first voltage VA are shown by a solid line and the transitions in the second voltage VB are shown by a broken line.

As shown in FIG. 3, during a closed period of the IG switch 45 to time t1, that is, when the power supply system 100 is in a paused state, the first to fourth switches SW1 to SW4 are in the closed state and the converter 12 is switched to the operation-stopped state. Therefore, during the closed period of the IG switch 45, the intersystem current IA is zero.

When the IG switch is set to the closed state at time t1, a close command is outputted to the first to fourth switches SW1 to SW4 and a command to switch the converter 12 to the operating state is outputted. As a result, the first and second switches are set to the closed state and the driving mode of the vehicle is set to the second mode.

In addition, the third and fourth switches SW3 and SW4 are set to the closed state and the converter 12 is switched to the operating state. As a result, the first and second voltages VA and VB increase. In the second mode, the first voltage VA is controlled to be equal to the second voltage VB. Therefore, a magnitude of the intersystem current IA is relatively small and direction of the intersystem current IA repeatedly varies.

Subsequently, when the command to switch to the first mode is inputted from the driver through the input unit 46, at time t2, the driving mode of the vehicle is switched from the second mode to the first mode. In the first mode, the first voltage VA is controlled to be the target voltage Vtg that is higher than the second voltage VB. As a result, the first state is set in which a load current flowing from the second system ES2 to the first system ES1 through the connection path LB is suppressed, and power supply from the converter 12 to the first load 34 and the second load 36 is performed.

In the first state, the intersystem current IA flows from the first system ES1 to the second system ES2 as a result of the voltage difference between the target voltage Vtg and the second voltage VB. In the control process according to the present embodiment, at time t2, the interruption determination is set to on and the determination that the current is flowing to the connection path LB, from the second system ES2 to the first system ES1, is started.

At time t2, the residual capacity SA of the second low-voltage storage battery 16 has not reached the capacity threshold Sth, and the second voltage VB has not increased to a drive voltage VM. Therefore, the second low-voltage storage battery 16 is charged by the converter 12. During charging of the second low-voltage storage battery 16, the target voltage Vtg is set to a voltage that is higher than the second voltage VB by the second voltage difference ΔV2.

Subsequently, when the second voltage VB increases to the drive voltage VM at time t3 and the residual capacity SA of the second low-voltage storage battery 16 reaches the capacity threshold Sth, charging of the second low-voltage storage battery 16 by the converter 12 is ended. After the end of charging of the second low-voltage storage battery 16, the target voltage Vtg is changed to a voltage that is higher than the second voltage VB by the first voltage difference ΔV1. That is, after the end of charging of the second low-voltage storage battery 16, the target voltage Vtg is set to be lower than that during charging of the second low-voltage storage battery 16.

A ground fault occurring in either of the first system ES1 and the second system ES2 is determined during traveling of the vehicle in the first mode. When the ground fault is determined to have not occurred in either of the first and second systems ES1 and ES2, the first and second switches SW1 and SW2 are kept in the closed state. As a result, power supply to the first and second loads 34 and 36 is performed from each of the converter 12 and the first and second low-voltage storage batteries 14 and 16. As a result of power supply from the converter 12, continuous power supply can be performed even during autonomous driving over an extended period of time. As a result of power supply from the first and second low-voltage storage batteries 14 and 16, power supply that has less voltage variations can be performed. Consequently, during the period from time t2 to time t4, autonomous driving and driving assistance using the first load 34 and the second load 36 are performed.

When the ground fault is determined to have occurred in either of the first and second systems ES1 and ES2, the first and second switches SW1 and SW2 are switched to the closed state. In FIG. 3, the ground fault occurs in the first system ES1 at time t4. As a result, the first voltage VA and the second voltage VB decrease. In addition, the intersystem current IA decreases.

As shown in FIG. 3(F), when the ground fault occurs in the first system ES1 at time t4, as a result of the decrease in the intersystem current IA, at subsequent time t5, the intersystem current IA decreases below zero. Then, as a result of the interruption determination, the reverse-direction current that is oriented from the second system ES2 to the first system ES1 is determined to flow to the connection path LB. In the control process according to the first embodiment, in the first mode, the load current flowing from the second system ES2 to the first system ES1 through the connection path LB is suppressed. Therefore, when the reverse-direction current is determined to flow to the connection path LB as a result of the interruption determination, the ground fault is determined to have occurred in the first system ES1.

When the ground fault is determined to have occurred in the first system ES1 at time t5, at time t5, the open command is outputted to the first and second switches SW1 and SW2, and the command to switch the converter 12 to the operation-stopped state is outputted. As a result, the second state is set in which power supply from the high-voltage storage battery 10 to the first load 34 and the second load 36, and power supply from the second low-voltage storage battery 16 to the first load 34 are stopped, and power supply from the second low-voltage storage battery 16 to the second load 36 is performed. As a result, the second voltage VB increases. In addition, in accompaniment with the switching from the first state to the second state, the interruption determination is turned off at time t5.

Subsequently, when the command to switch to the second mode is inputted from the driver through the input unit 46, at time t6, the driving mode of the vehicle is switched from the first mode to the second mode.

According to the present embodiment described in detail above, the following effects are achieved.

According to the present embodiment, the first and second switches SW1 and SW2 are provided on a first connection path LB1 that connects the first and second systems ES1 and ES2 to each other. Therefore, as a result of the first and second switches SW1 and SW2 being set to the closed state, mutual power supply between the first and second systems ES1 and ES2 can be performed. Redundant power supply to the first load 34 and the second load 36 by the converter 12, and the first and second low-voltage storage batteries 14 and 16 can be performed. In addition, when an abnormality is determined to have occurred in either of the first and second systems ES1 and ES2, as a result of the first and second switches SW1 and SW2 being set to the closed state, driving of the loads 34 and 36 in the other of the first and second systems ES1 and ES2 in which an abnormality has not occurred can be continued.

In this configuration of the present embodiment, during driving of the first load 34 and the second load 36, as a result of the first voltage VA being made higher than the second voltage VB, power supply is performed from the converter 12 to the first load 34 and the second load 36. As a result, the intersystem current IA flowing from the second system ES2 to the first system ES1 through the connection path LB is suppressed. Therefore, when the reverse-direction current that is oriented from the second system ES2 to the first system ES1 flows to the connection path LB, the current generation can be determined to be actually due to an abnormality. In addition, as a result of the first and second switches SW1 and SW2 being set to the open state, power supply can be performed from the second low-voltage storage battery 16 to the second load 36. That is, driving of the second load 36 can be continued even when an abnormality occurs in the first system ES1. Consequently, driving of the loads 34 and 36 can be continued even when an abnormality has occurred, while erroneous detection of an abnormality is suppressed.

According to the present embodiment, the first load 34 and the second load 36 are loads that provide functions that are required for driving and driving assistance functions. Switching can be performed between traveling in the first mode in which the driving assistance function is used through use of the loads 34 and 36, and traveling in the second mode in which the driving assistance function is not used. In addition, in the first mode, as a result of the first voltage VA being set to the target voltage Vtg that is higher than the second voltage VB, power supply is performed from the converter 12 to the first load 34 and the second load 36. In addition, when the reverse-direction current that is oriented from the second system ES2 to the first system ES1 is determined to flow to the connection path LB in the first mode, as a result of the first and second switches SW1 and SW2 being set to the open state, power supply is performed from the second low-voltage storage battery 16 to the second load 36. Consequently, in the first mode in which the driving assistance function is used, driving of the loads 34 and 36 can be continued even when an abnormality occurs and the driving assistance function can be continuously used, while erroneous detection of an abnormality is suppressed.

According to the present embodiment, the converter 12 is capable of variably controlling the first voltage VA, and controls the first voltage VA based on the target voltage Vtg that has the predetermined voltage difference AVI or ΔV2 relative to the second voltage VB. Therefore, when the first voltage VA is set to the target voltage Vtg, the predetermined voltage difference ΔV1 or ΔV2 is ensured between the first voltage VA and the second voltage VB. As a result, during driving of the first load 24 and the second load 36, even when the intersystem current IA that flows from the first system ES1 to the second system ES2 through the connection path LB varies, the reverse-direction current can be suppressed, by the voltage difference AVI or ΔV2, from flowing by way of the connection path LB. Consequently, erroneous detection of an abnormality can be suppressed.

According to the present embodiment, the first system ES1 includes the converter 12 that steps down the electric power that is supplied from the high-voltage storage battery 10 and generates electric power of the first voltage VA. Therefore, in the converter 12, the first voltage VA can be generated as the drive voltage of the first load 24 and the second load 36, and the first voltage VA can be supplied to the loads 34 and 36. In addition, because the second system ES2 includes the second low-voltage storage battery 16, even if power supply failure occurs in the first system ES1, power supply to the loads 34 and 36 can be continued. Here, a charging power is supplied as appropriate from the converter 12 to the second low-voltage storage battery 16 based on decrease in the second voltage VB. During driving of the first load 34 and the second load 36, when the charging power is supplied from the converter 12 to the second low-voltage storage battery 16 through the connection path LB, variations in the charging current that flows through the connection path LB occur as a result of the residual capacity SA of the second low-voltage storage battery 16. As a result, when the reverse-direction current flows by way of the connection path LB, an abnormality is erroneously detected. In this regard, according to the present embodiment, when the second low-voltage storage battery 16 is being charged, the target voltage Vtg is set to be higher than that when the second low-voltage storage battery 16 is not being changed. Consequently, the reverse-direction current can be suppressed from flowing, and erroneous detection of an abnormality can be favorably suppressed.

### Second Embodiment

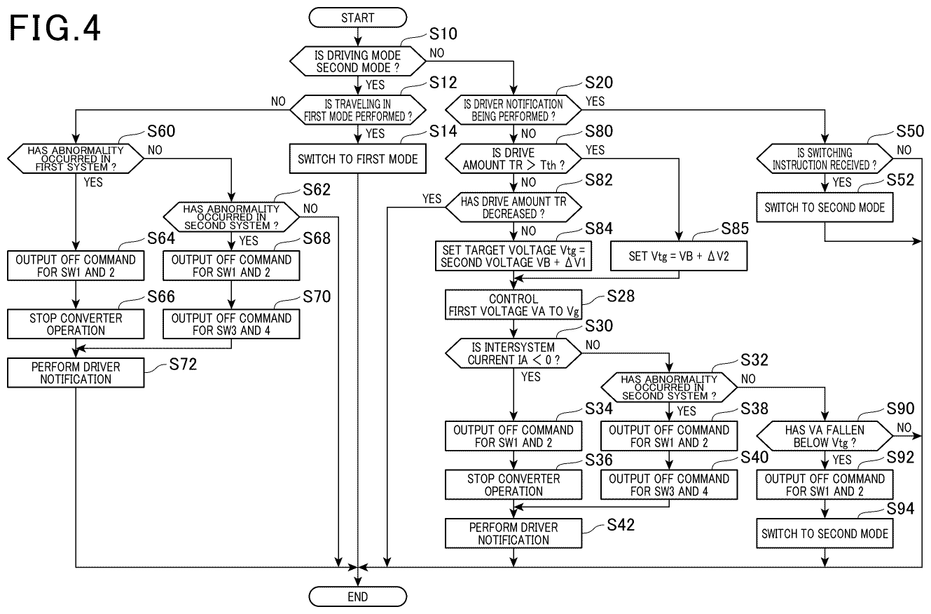

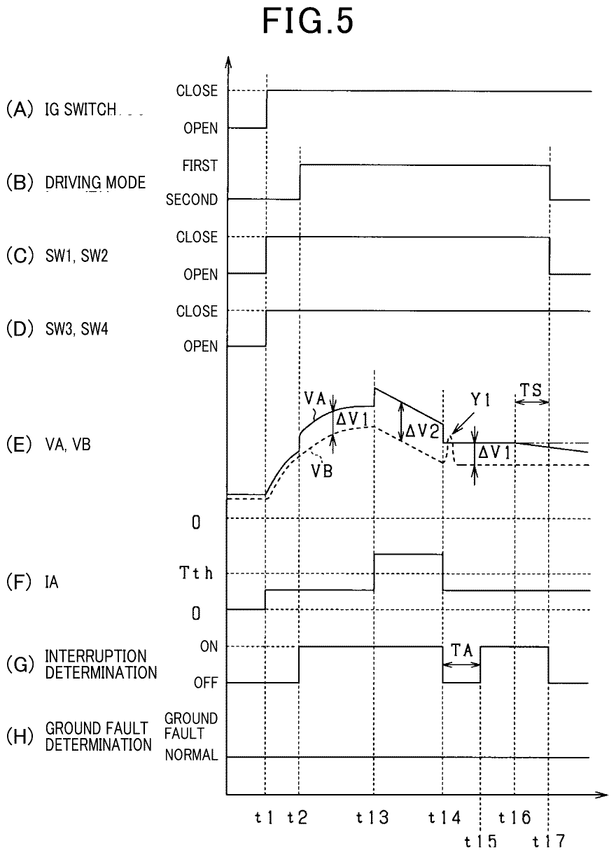

A second embodiment will be described below with reference to FIG. 4 and FIG. 5, mainly focusing on differences with the first embodiment.

The present embodiment differs from the first embodiment in that, in the first mode, drive amount information that indicates a drive amount TR of the first load 34 and the second load 36 is acquired. For example, in the electric power steering apparatus 50, the drive amount TR may be output torque. The drive amount information is information that indicates a command value of the output torque.

In addition, the present embodiment differs from the first embodiment in that, in the first mode, the first voltage VA and the target voltage Vtg are compared, and the driving mode is switched from the first mode to the second mode based on a comparison result.

FIG. 4 shows a flowchart of a control process according to the present embodiment. In FIG. 4, processes that are identical to the processes shown in FIG. 2 above are given the same step numbers for convenience. Descriptions thereof are omitted.

In the control process of the present embodiment, when an affirmative determination is made at step S20, at step S80, the drive amount information of the first load 34 and the second load 36 is acquired, and whether the drive amount TR that is indicated by the acquired drive amount information is greater than a predetermined drive amount threshold Tth is determined. Here, the drive amount threshold Tth is a drive amount at which a variation that is greater than the second voltage difference ΔV2 is likely to occur in the intersystem current IA.

When the drive amount TR is less than the drive amount threshold Tth, a negative determination is made at step S80. In this case, at step S82, whether the drive amount TR has decreased beyond the drive amount threshold Tth is determined. Specifically, whether the drive amount TR has switched from a state of being greater than the drive amount threshold Tth to a state of being less than the drive amount threshold Tth is determined. The drive amount information that is acquired in each control process is stored in a memory within the control apparatus 40. At step S82, whether the drive amount TR that is acquired in a previous control process is greater than the drive amount threshold Tth is determined.

When the drive amount TR that is acquired in the previous control process is greater than the drive amount threshold Tth and the drive amount TR has switched from the state of being greater than the drive amount threshold Tth to the state of being less than the drive amount threshold Tth, an affirmative determination is made at step S82. In this case, at step S30, the control process is ended without whether a current flows to the connection path LB from the second system ES2 to the first system ES1 being determined. In this case, even if the reverse-direction current flows by way of the connection path LB, switching of the first and second switches SW1 and SW2 to the open state at step S34 is not performed, and the switching process is stopped.

Meanwhile, when the drive amount TR that is acquired in the previous control process is less than the drive amount threshold Tth and the drive amount TR has not switched from the state of being greater than the drive amount threshold Tth to the state of being less than the drive amount threshold Tth, a negative determination is made at step S82. In this case, at step S84, the target voltage Vtg is set such that the voltage difference between the target voltage Vtg and the second voltage VB is the first voltage difference ΔV1.

Meanwhile, when the drive amount TR is greater than the drive amount threshold Tth, an affirmative determination is made at step S80. In this case, at step S85, the target voltage Vtg is set such that the voltage difference between the target voltage Vtg and the second voltage VB is the second voltage difference ΔV2. Here, the second voltage difference ΔV2 is set to a voltage difference that is greater than the first voltage difference ΔV1. Therefore, in the control process according to the present embodiment, the target voltage Vtg when the drive amount TR is greater than the drive amount threshold Tth is set to be higher than that when the drive amount TR is less than the drive amount threshold Tth.

In addition, when a negative determination is made at step S32, at step S90, whether the first voltage VA is lower than the target voltage Vtg is determined. Specifically, whether the first voltage VA is held in a state of being lower than the target voltage Vtg over a predetermined period TS is determined. Here, according to the present embodiment, the process at step S90 corresponds to a “voltage determining unit.”

For example, when the first voltage VA cannot be increased to the target voltage Vtg as a result of an abnormality in the high-voltage storage battery 10 or decrease in the SOC of the high-voltage storage battery 10, the state in which the first voltage VA is lower than the target voltage Vtg may be maintained over the predetermined period TS. Therefore, the first voltage VA is determined to be lower than the target voltage Vtg and an affirmative determination is made at step S90. In this case, at step S92, the open command is outputted to the first and second switches SW1 and SW2. At subsequent step S94, the driving mode of the vehicle is switched from the first mode to the second mode, and the control process is ended. Here, according to the present embodiment, the process at step S94 corresponds to a “mode control unit.”

Meanwhile, when the state in which the first voltage VA is lower than the target voltage Vtg is not continued over the predetermined period TS, the first voltage VA is determined to not be lower than the target voltage Vtg, and a negative determination is made at step S90. In this case, the control process is ended without the driving mode of the vehicle being switched from the first mode to the second mode.

Next, FIG. 5 shows an example of the control process. FIG. 5 shows transitions in the first voltage VA and the second voltage VB when the first voltage VA falls below the target voltage Vtg during traveling of the vehicle in the first mode.

In FIG. 5, (F) shows transitions in the drive amount TR. Here, (A) to (E), (G), and (H) in FIG. 5 are identical to (A) to (E), (G), and (H) in FIG. 2. In addition, a process from time t1 to time t2 in FIG. 5 is identical to the process from time t1 to time t2 in FIG. 2. Therefore, redundant descriptions are omitted.

As shown in FIG. 5, when the IG switch 45 is set to the closed state at time t1, acquisition of the drive amount information is started and whether the drive amount TR that is indicated by the acquired drive amount information is greater than the drive amount threshold Tth is determined.

Subsequently, when an instruction to switch to the first mode is inputted from the driver through the input unit 46, the driving mode of the vehicle is switched from the first mode to the second mode at time t2. At time t2, the drive amount TR is less than the drive amount threshold Tth. Therefore, the target voltage Vtg is set to a voltage that is higher than the second voltage VB by the first voltage difference ΔV1.

Subsequently, when the drive amount TR increases beyond the drive amount threshold Tth at time t13, the second voltage VB decreases. In addition, in accompaniment with the increase in the drive amount TR, the target voltage Vtg changes to a voltage that is higher than the second voltage VB by the second voltage difference ΔV2. That is, the target voltage Vtg when the drive amount TR is greater than the drive amount threshold Tth is set to be higher than that when the drive amount TR is less than the drive amount threshold Tth.

Subsequently, when the drive amount TR is less than the drive amount threshold Tth at time t14, the target voltage Vtg changes to a voltage that is higher than the second voltage VB by the first voltage difference ΔV1. In addition, in accompaniment with the decrease in the drive amount TR, the decrease in the second voltage VB stops. As shown in FIG. 5(E), after the decrease in the drive amount TR, the second voltage VB becomes unstable and a sudden change in the second voltage VB occurs as shown by arrow Y1. Then, when a maximum value of the second voltage VB that has suddenly changed exceeds the target voltage Vtg, the reverse-direction current is determined to flow through the connection path LB. The first and second switches SW1 and SW2 are erroneously switched to the open state.

Therefore, in the control process according to the present embodiment, when the drive amount TR switches from the state of being greater than the drive amount threshold Tth to the state of being less, the interruption determination is turned off during a period from when the drive amount TR enters the state of being less than the drive amount threshold Tth until elapse of a first period TA. Specifically, the interruption determination is turned off during the first period TA from time t14 to time t15. As a result, the first and second switches SW1 and SW2 being erroneously switched to the on state as a result of a sudden change in the second voltage VB that occurs during the first period TA is suppressed.

Subsequently, when the first voltage VA falls below the target voltage Vtg as a result of decrease in the SOC of the high-voltage storage battery 10, the driving mode of the vehicle is switched from the first mode to the second mode. In FIG. 5, the first voltage VA starts to decrease from the target voltage Vtg at time t16. Then, when the state in which the first voltage VA is lower than the target voltage Vtg is maintained over the predetermined period TS from time t16 to time t17, the first voltage VA is determined to have fallen below the target voltage Vtg at time t17.

When the first voltage VA is determined to have fallen below the target voltage Vtg at time t17, at time t17, the open command is outputted to the first and second switches SW1 and SW2, and the command to switch the converter 12 to the operation-stopped state is outputted. As a result, the second state is set in which power supply from the high-voltage storage battery 10 to the first load 34 and the second load 36 and power supply from the second low-voltage storage battery 16 to the first load 34 are stopped, and power supply is performed from the second low-voltage storage battery 16 to the second load 36. In addition, in accompaniment with the switching from the first state to the second state, the interruption determination is turned off at time t17.

Furthermore, in the control process according to the present embodiment, at time t17, the driving mode of the vehicle is switched from the first mode to the second mode. As a result, in a state in which the SOC of the high-voltage storage battery 10 is decreased, traveling of the vehicle in the first mode in which the driving assistance function is used is stopped.

According to the present embodiment described in detail above, the following effects are achieved.

An amount of change in the current that flows through the connection path LB is proportional to the drive amount TR of the first load 34 and the second load 36. Therefore, when the drive amount TR is large, the amount of change in the current that flows through the connection path LB increases. As a result, when a reverse-direction current flows by way of the connection path LB, an abnormality is erroneously detected. In this regard, the first voltage VA when the drive amount TR is greater than the drive amount threshold Tth is set to be higher than that when the drive amount TR is less than the drive amount threshold Tth. Consequently, the reverse-direction current is suppressed from flowing, and erroneous detection of an abnormality can be favorably suppressed.

In particular, when the drive amount TR decreases, the second voltage VB becomes unstable and the current that flows through the connection path LB tends to increase. In this case, when the reverse-direction current is determined to flow to the connection path LB, the first and second switches SW1 and SW2 are erroneously set to the open state as a result of erroneous detection of an abnormality. In this regard, according to the present embodiment, when the drive amount TR switches from the state of being greater than the drive amount threshold Tth to the state of being less, the process for switching the first and second switches SW1 and SW2 to the open state is stopped. Consequently, the first and second switches SW1 and SW2 being erroneously set to the open state as a result of erroneous detection of an abnormality can be suppressed.

In the first mode, for example, the first voltage VA may not be able to be increased to the target voltage Vtg as a result of decrease in the SOC of the high-voltage storage battery 10. In this case, the voltage difference between the first voltage VA and the second voltage VB decreases, and an abnormality is erroneously detected depending on a magnitude of variations in the drive amount TA. When the first and second switches SW1 and SW2 are erroneously set to the open state as a result of erroneous detection of an abnormality in the first mode in which the driving assistance function is used, redundant power supply to the loads 34 and 35 cannot be performed in the driving assistance function. In this regard, according to the present embodiment, when the first voltage VA falls below the target voltage Vtg, a traveling mode of the vehicle is switched from the first mode to the second mode. Consequently, the driving assistance function being continuously used in a state in which redundant power supply to the loads 34 and 36 cannot be performed can be suppressed.

### Other Embodiments

The present disclosure is not limited to the described content according to the above-described embodiments and may be carried out in a following manner. For example, the loads 34 and 36 may be the following apparatuses.

The loads 34 and 36 may be a motor for traveling that applies power for traveling to the vehicle, and a drive circuit thereof. In this case, for example, the first and second loads 34 and 36 may be respectively a three-phase permanent-magnet synchronous motor and a three-phase inverter apparatus.

The loads 34 and 36 may be an anti-lock brake apparatus that prevents locking of wheels during braking. In this case, for example, the first and second loads 34 and 36 may be each an anti-lock braking system (ABS) actuator that independently adjusts brake hydraulic pressure during braking.

The loads 34 and 36 may be a cruise control apparatus that detects a leading vehicle that travels ahead of an own vehicle. When the leading vehicle is detected, the cruise control apparatus maintains a fixed inter-vehicle distance to the leading vehicle. When the leading vehicle is no longer detected, the cruise control apparatus makes the own vehicle travel at a vehicle speed that is set in advance. In this case, for example, the first and second loads 34 and 36 may be each a millimeter-wave radar.

The loads 34 and 36 are not necessarily required to be a combination of identical configurations and may be a combination in which an equivalent function is actualized by apparatuses of differing forms.

The first and second switches SW1 and SW2 are not limited to the MOSFET and, for example, may be an insulated-gate bipolar transistor (IGBT). This similarly applies to the third and fourth switches SW3 and SW4.

The voltage generating unit that is included in the first system ES1 is not limited to the converter 12 and may be an alternator. In addition, the first system ES1 may not include the voltage generating unit and, for example, may only include the first low-voltage storage battery 16.

According to the above-described embodiments, an example in which the target voltage Vtg is set to be higher than the second voltage VB based on the second voltage VB is described. However, this is not limited thereto. The first voltage VA and the second voltage VB may be acquired, and the target voltage Vtg may be set to be higher than the second voltage VB based on the voltage difference between first voltage VA and the second voltage VB. In addition, the magnitude and the direction of the intersystem current IA may be acquired, and the target voltage Vtg may be set to be higher than the second voltage VB based on the magnitude and the direction.

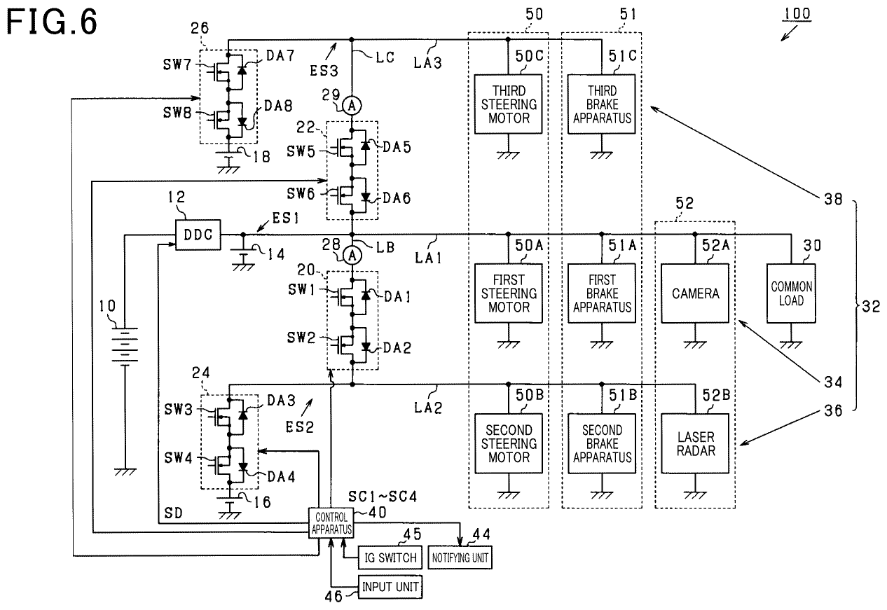

According to the above-described embodiments, an example in which one each of the first and second systems are provided is described. However, this is not limited thereto. As shown in FIG. 6, a single first system and two second systems may be provided.

Hereafter, the two second systems are referred to as a second system ES2 and a third system ES3. In this case, as a result of the first voltage VA of the first system ESI being set to be higher than the second voltage VB of the second system ES2 and a third voltage VC that is an inter-terminal voltage of a third low-voltage storage battery 18 of the third system ES3, driving of the loads 34 and 36 can be continued even when a short circuit occurs, while erroneous detection of a short circuit is suppressed.

According to the above-described embodiments, in the setting of the target voltage Vtg, an example in which the target voltage when the second low-voltage storage battery 16 is being charged is set to be higher than that when the second low-voltage storage battery 16 is not being charged is described. However, this is not limited thereto. For example, the target voltage Vtg may be set to be lower as the residual capacity SA of the second low-voltage storage battery 16 increases.

In addition, an example in which the target voltage Vtg when the drive amount TR is greater than the drive amount threshold Tth is set to be higher than that when the drive amount TR is less than the drive amount threshold Tth is described. However, this is not limited thereto. For example, the target voltage Vtg may be set to be higher as the drive amount TR increases.

According to the above-described embodiments, an example in which the first state is set in the first mode is described. However, the first state may be set regardless of the driving mode of the vehicle.

According to the above-described embodiments, an example in which the power supply system 100 is applied to a vehicle that is capable of traveling by manual driving and autonomous driving is described. However, this is not limited thereto. The power supply system 100 may be applied to a vehicle that is capable of traveling only by autonomous driving, such as a fully autonomous car. Alternatively, the power supply system 100 may be applied to a vehicle that is only capable of traveling by manual driving.

For example, when the power supply system 100 is applied to a vehicle that is capable of traveling only by autonomous driving, when an abnormality occurs in either of the first and second systems ES1 and ES2, a process may be performed in which the traveling of the vehicle by autonomous driving is stopped or the vehicle is stopped after being moved to a safe location using the loads 34 and 36 of the other of the first and second systems ES1 and ES2 in which an abnormality has not occurred.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A control apparatus that is applicable to a power supply system, the power supply system including a first system, a second system, a connection path, and an intersystem switch, the first system including a first power supply that is connected to a first load, the second system including a second power supply that is connected to a second load, the connection path connecting the first and second systems to each other, and the intersystem switch being provided on the connection path, the control apparatus comprising:
a first control unit that sets the intersystem switch to a closed state and sets a first voltage that is a voltage of the first power supply to be higher than a second voltage that is a voltage of the second power supply to be a first state in which and power supply is performed from the first power supply to the first and second loads; and
a second control unit that, in response to a reverse-direction current that is oriented from the second system to the first system flowing to the connection path in the first state, sets the intersystem switch to an open state to be a second state in which power supply is performed from the second power supply to the second load, wherein:
the first control unit
acquires drive amount information that indicates a drive amount of the first load and the second load, and
when the drive amount indicated by the drive amount information is greater than a predetermined threshold, sets the first voltage to be higher than that when the drive amount is less than the threshold.

2. The control apparatus according to claim 1, wherein:
the first control unit acquires drive amount information that indicates a drive amount of the first load and the second load; and
the second control unit stops switching of the intersystem switch to the open state even when the reverse-direction current is determined to be flowing, in response to the drive amount indicated by the drive amount information acquired by the first control unit switching from a state of being greater than a predetermined threshold to a state of being less than the predetermined threshold.

3. A control apparatus that is applicable to a power supply system, the power supply system including a first system, a second system, a connection path, and an intersystem switch, the first system including a first power supply that is connected to a first load, the second system including a second power supply that is connected to a second load, the connection path connecting the first and second systems to each other, and the intersystem switch being provided on the connection path, the control apparatus comprising:
a first control unit that sets the intersystem switch to a closed state and sets a first voltage that is a voltage of the first power supply to be higher than a second voltage that is a voltage of the second power supply to be a first state in which, and power supply is performed from the first power supply to the first and second loads; and
a second control unit that, in response to a reverse-direction current that is oriented from the second system to the first system flowing to the connection path in the first state, sets the intersystem switch to an open state to be a second state in which power supply is performed from the second power supply to the second load, wherein:
the first control unit acquires drive amount information that indicates a drive amount of the first load and the second load; and
the second control unit stops switching of the intersystem switch to the open state even when the reverse-direction current is determined to be flowing, in response to the drive amount indicated by the drive amount information acquired by the first control unit switching from a state of being greater than a predetermined threshold to a state of being less than the predetermined threshold.

4. The control apparatus according to claim 3, wherein:
the power supply system is mounted to a vehicle;
the first load and the second load provide at least one function required for driving of the vehicle that includes a driving assistance function of the vehicle;
the vehicle is capable of traveling in a first mode in which the driving assistance function is used and traveling in a second mode in which the driving assistance function is not used;
the first control unit sets the first state in the first mode;
the second control unit sets the second state in response to the reverse-direction current being determined to be flowing in the first mode.

5. The control apparatus according to claim 1, wherein:
the first control unit acquires drive amount information that indicates a drive amount of the first load and the second load; and
the second control unit stops switching of the intersystem switch to the open state even when the reverse-direction current is determined to be flowing, in response to the drive amount indicated by the drive amount information acquired by the first control unit switching from a state of being greater than a predetermined threshold to a state of being less.

6. The control apparatus according to claim 4, wherein:
the first control unit controls the first voltage to be a target voltage that is higher than the second voltage; and
the control apparatus includes
a voltage determining unit that determines that the first voltage has fallen below the target voltage in the first state, and
a mode control unit that switches a traveling mode of the vehicle from the first mode to the second mode in response to the first voltage being determined to have fallen below the target voltage.
